(19) United States
(12) Patent Application Publication
(10) Pub. No.: US 2014/0371049 A1
(43) Pub. Date: Dec. 18, 2014

(54) CENTRIFUGAL SEPARATOR WITH ANTI-FOULING PROPERTIES

(71) Applicant: ALFA LAVAL CORPORATE AB, Lund (SE)

(72) Inventors: Mats Nilsson, Lund (SE); Jonas Anehamre, Lund (SE); Stefan Szepessy, Huddinge (SE); Tom Manelius, Mariefred (SE)

(21) Appl. No.: 14/360,801

(22) PCT Filed: Nov. 28, 2012
(86) PCT No.: PCT/EP2012/004914

§ 371 Date: May 27, 2014

(30) Foreign Application Priority Data
Nov. 28, 2011 (SE) 1151127.6

(51) Int. Cl. B04B 15/06; B04B 7/08

(52) U.S. Cl. CPC B04B 15/06; B04B 7/08
USPC 494/64

(57) ABSTRACT

A centrifugal separator for continuous separation of a fluid mixture into components includes a rotor, which forms within itself a separation chamber, including in said separation chamber a set of separation discs defining separation passages between adjacent separation discs. The separator further includes an inlet operatively connected to said rotor for continuous supply of a fluid mixture to be separated in the separation chamber, a first outlet for a separated lighter first component of the fluid mixture extending from a radially inner portion of the separation space, and a second outlet for a separated denser second component of the fluid mixture extending from the radially outer portion of the separation space. The separation discs are provided with a coating including silicon oxide, SiOₓ, prepared through sol-gel processing.

### TECHNICAL FIELD

The present invention relates to a centrifugal separator according to the preamble of claim 1 which has been coated for improving anti-fouling properties.

### BACKGROUND ART

Fouling is a generally known problem within centrifugal separators. During operation, fouling of e.g. separator discs, frame and sludge outlet channels is of concern, for example due to deposits, microbial growth, dirt etc. that arise from the fluids that pass through the centrifugal separator. In particular, fouling of the separator discs may reduce the throughput rate of the separator if its separation capability is to remain unchanged. Furthermore, deposits formed on the separator discs may have to be removed periodically, i.e. the discs and the interior of the separator being cleaned. In a separator arranged for continuous throughput, stoppages for removing deposits results in undesired downtime of the separator and, consequently, a reduced overall separation capacity.

In modern centrifugal separators, the rotor body and its inner parts are made of stainless steel, and the surfaces of the rotor parts which contact the liquid are polished so as to prevent as much as possible the accumulation of deposits on these surfaces. In spite of this polishing, deposits are formed which must be removed periodically so that the desired separation capability can be maintained.

U.S. Pat. No. 3,741,467 discloses an attempt to overcome this problem by coating surfaces subjected to fouling with a flourinated polyalkene, such as polytetrafluoroethylene (PTFE). However, a drawback of such a coating is that it may wear off in applications with abrasive media. Another is that the coating has a required thickness that is not insignificant in relation to, e.g., the disc thickness.

It would be desirable to find new ways to ensure less fouling of centrifugal separators and especially their discs, sludge outlet channels and frame in order to keep the centrifugal separators running for longer time periods. Also, a reduced shut down time for processes where centrifugal separators are involved would be desirable.

As indicated above, a problem encountered with presently known anti-fouling coatings is poor wear resistance of the coatings in applications with abrasive media, e.g. sand or other particulate material which enters the centrifugal separator with the fluids which are to be separated. Furthermore, cracks in the coating may occur due to friction and buckling forces acting on the centrifugal separator discs or abrasion at the salient edges.

### SUMMARY OF THE INVENTION

It is an object of the invention to provide an improved centrifugal separator, which show a reduced fouling. Another object is to provide embodiments of a centrifugal separator which are wear resistant in abrasive environments and have high resistance against formation of cracks.

This object is achieved by a centrifugal separator arranged for continuous separation of a fluid mixture into components, comprising a rotor, which forms within itself a separation chamber. The rotor comprises in said separation chamber a set of separation discs defining separation passages between adjacent separation discs; an inlet operatively connected to said rotor for continuous supply of a fluid mixture to be separated in the separation chamber, a first outlet for a separated lighter first component of the fluid mixture extending from a radially inner portion of the separation space, and a second outlet for a separated denser second component of the fluid mixture extending from the radially outer portion of the separation space. The separation discs are at least partly provided with a coating that has a layer thickness of about 5-60 μm, is prepared by sol-gel processing, comprises silicon oxide, SiOx, having an atomic ratio of O/Si>1, and comprises 10 atomic % of carbon.

The centrifugal separator is advantageous in that fouling of the disc surfaces is significantly reduced. By applying a coating composition comprising sol-gel material with organosilicon compounds to the separation disc surfaces, both the surface free energy and roughness is lowered, leading to reduction of fouling, less and easy cleaning of the centrifugal separator. Moreover, the sol-gel coated centrifugal separator of the invention exhibit an excellent wear resistance and have a flexibility that reduces the risk of cracks appearing in the coating. This is achieved by the very low thickness of the coating, which is possible through the preparation thereof by sol-gel processing.

The layer thickness of said coating on the centrifugal separator surfaces may be 5-50 μm, preferably 5-20 μm. The ability to provide a layer thickness of the coating that is significantly less than the disc thickness, i.e. tens of μm compared to hundreds of μm, the coating does not result in any significant reduction of the height of the separation passage, which otherwise could lead to reduced flow capacity, requiring higher speed to obtain the same separation performance, and increased risk of clogging the separation passages. A further advantage of a small layer thickness is that there will not have to be any significant reduction in the number of discs that can be fitted into a same height disc stack, as compared to a stack of non-coated discs. This is a great improvement in comparison to for instance a tetrafluoropolyethylene coating which would require a thickness in the order of 100 μm, and thereby either negatively impact on the number of discs that could be fitted into a disc stack of a given height, or negatively impact on the height of the separation passage. Either way, the separation performance would be detrimentally affected, either by restricting the flow through the separation passages, or reducing the total separation area through a reduction in the number of discs.

The silicon oxide, SiOₓ, coating may have an atomic ratio O/Si of 1.5-3, preferably of 2-2.5.

The coating may have a content of carbon of 20-60 atomic %, preferably of 30-40 atomic %.

The centrifugal separator may have a third outlet for a separated third component of the fluid mixture extending from the radially outer portion of the separation space.

The separation discs may have a thickness of 0.3-2 mm, preferably 0.4-1 mm, more preferably 0.5-0.8 mm.

### BRIEF DESCRIPTION OF THE DRAWINGS

Further objects, features and advantages of the invention will appear from the following detailed description of different embodiments of the invention with reference to the accompanying schematic drawings, in which

FIG. 1 schematically shows an axial section of one embodiment of a centrifugal separator for continuous operation,

FIGS. 2a-2c schematically illustrates embodiments of different types of centrifugal separators,

FIG. 3 is a schematic cross section of a separation disc surface comprising an anti-fouling coating.

### DETAILED DESCRIPTION OF THE INVENTION

In the following, embodiments of centrifugal separators for continuous throughput are described. However, it should be known that the present invention is applicable to any continuous operation centrifugal separator comprising separation discs, which during operation is subjected to media causing fouling of the disc surfaces.

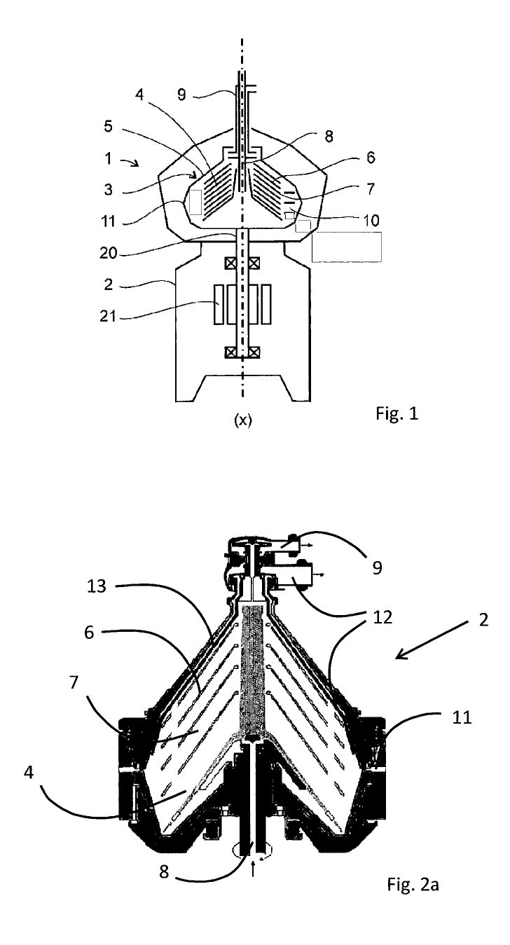

FIG. 1 shows, in schematic form, a centrifugal separator 1 for separating a fluid mixture into components, such as for separating water and particles from an oil based fluid mixture. The separator has a frame 2 supporting a centrifugal rotor 3 around a rotational axis x by means of a spindle 20 connected to the frame by a first and a second bearing. The rotor is driven by a motor, such as an electric direct drive motor 21 as illustrated. The rotor forms within itself a separation space 4, delimited by a rotor wall 5, wherein a set of separation plates 6 in the form of a stack of frustoconical separation discs is arranged. The separation discs forms separation passages 7 between each pair of adjacent discs. A stationary inlet 8 extends into the rotor for supply of a fluid mixture to be separated to the separation space. A first outlet 9 for a separated lighter first component of the fluid mixture extends from a radially inner portion of the separation space. A sludge space 10 is defined as an annular portion of the separation space radially outside the separation plates, and a second outlet 11 for discharge of a separated denser second component of the fluid mixture extends from the radially outer portion of the sludge space.

Each separation disc is provided with a number of openings or cut-outs distributed around the periphery of each disc to form passages extending through the stack in an axial direction to distribute the flow of fluid to be separated through and over the disc stack. The rotor further comprises a distributor delimiting a central inlet space in the rotor, which is connected to the separation space 4 via passages in the rotor. The distributor supports the stack of separation discs 6. A stationary inlet 8 extends into the inlet space for supply of a fluid mixture to be separated. A first outlet 9 for a separated lighter first component of the fluid mixture extends from a radially inner portion of the separation space 4. A sludge space 10 is defined as an annular portion of the separation space radially outside the separation discs. A plurality of second outlets 11 distributed around the circumference of the rotor extend from the radially outer portion of the sludge space for discharge of a separated denser second component of the fluid mixture, denoted sludge. The opening of the second outlets 11 is controlled by an operating slide arranged to be displaced from the closed position in short periods of time for discharge of the sludge collected in the sludge space, as known in the art.

During operation, the rotor 3 is rotated at an operational speed, a fluid mixture to be separated into components is introduced into the inlet space of the rotor by the inlet 8. The fluid is transported to the separation space via passages in the rotor, by means of centrifugal forces. The flow of fluid is then distributed over the stack of separation discs 6 via the axial passages provided by the cut-outs in the discs, and into the separation passages 7 between adjacent separation discs. In the separation passages denser and lighter components of the fluid mixture are separated. Lighter components of the fluid (e.g. oil) are transported radially inwardly towards the first outlet 9 for a separated lighter first component of the fluid mixture, which first outlet extends from a radially inner portion of the separation space. Denser components of the fluid (such as water and solid particulate matter, i.e. sludge) are transported radially outwardly in the separation space towards the sludge space 10, inside the second outlets 11.

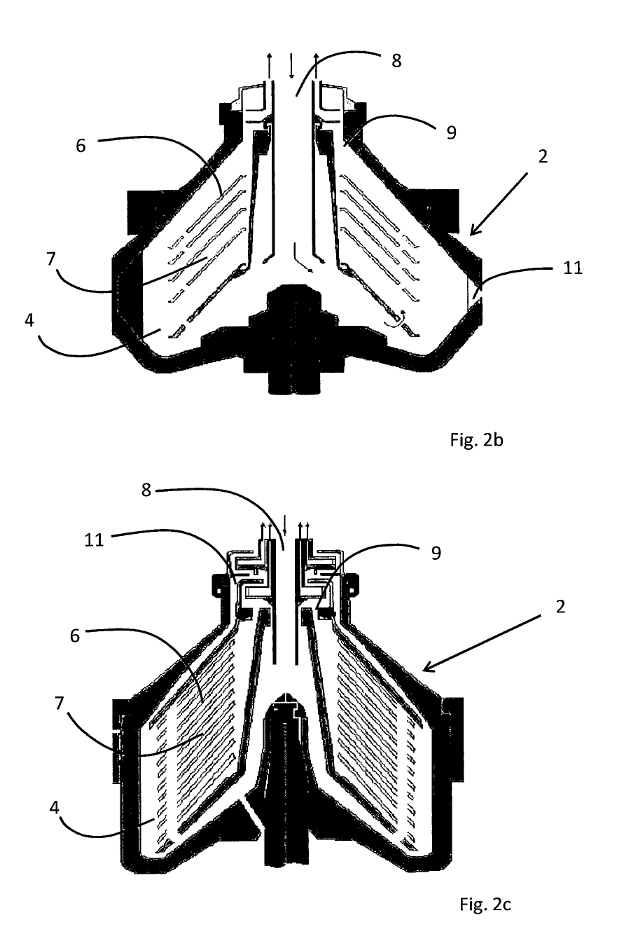

In an embodiment shown in FIG. 2a, the centrifugal separator as previously described further comprises a third outlet 12 for a third component, denser than the first component, extending from the radially inner portion of the sludge space. This denser third component of the fluid mixture may be a denser liquid component, such as water. A top disc 13 is provided at the upper end of the stack of separation discs. The top disc 13 delimits a passage between the top disc and the rotor wall for a denser third component separated from the fluid mixture extending from the radially inner portion of the sludge space, connected to the third outlet. The top disc is configured to extend radially outside the frustoconical plates. Among the denser components separated from the fluid mixture, the least dense components, such as water, flow over the radially outer edge of the top disc 13 towards the third outlet 12. From the third outlet chamber, fluid may be peeled by a peeling device as known in the art.

FIGS. 2a-2c illustrates various embodiments of centrifugal separators for continuous operation and throughput, each comprising a rotor 3, a stack of separation discs 6, forming separation passages 7 between each pair of adjacent discs. FIG. 2a schematically illustrates a centrifugal separator with intermittent discharge of solids or sludge, or a denser component. As mentioned above, in the embodiment of FIG. 2a a centrifugal separator is illustrated having two outlets 9, 12 for lighter phases of different density, and an outlet 11 for the heavy phase, solids or sludge. However, embodiments having one light phase outlet and one heavy phase outlet with intermittent discharge is also contemplated. The intermittent discharge is automatic in the manner described above.

FIG. 2b schematically illustrates a nozzle type centrifugal separator for continuous operation, also referred to as an automatic, continuous solids discharge separator. Further to the elements referred to above, the separator comprises a first outlet 9 for the light phase separated media, and a second outlet 11 for continuous discharge of the heavy phase separated media, or sludge. Said second outlet 11 is in the form of a plurality of circumferentially distributed outlet ports of nozzles.

FIG. 2c illustrates a solid bowl centrifugal separator. The separator comprises a first outlet 9 for a light phase separated media, and a second outlet 11 for the heavier phase separated media. Solids caught within the bowl, i.e. that are not output through the second outlet 11, is accumulated at a radially outer portion thereof, and is manually removed.

Thus, several common types of centrifugal separators for continuous operation and continuous throughput are described above. However, the present invention is not limited to the described types of separators. For instance, the invention is equally applicable to hermetic and non-hermetic separators, continuous or intermittent discharge separators, solid bowl separators, etc. In other words, the present invention is applicable to any continuous operation centrifugal separator comprising separation discs, which during operation is subjected to media causing fouling of the disc surfaces.

As mentioned above, the separation plates 6 are arranged in the form of a stack of frustoconical separation discs. The separation discs forms separation passages between each pair of adjacent discs, typically provided through the arrangement of circumferentially distributed caulks on the surface of each disc. The number of discs is typically in the range of a few tens to several hundred, depending on the application, media to be separated and type of separator. The caulk thickness, defining the distance between the adjacent discs and thereby the height of the separation passage, is typically between 0.3 and 2 mm.

The separation discs or plates comprises a coating used for improving the anti-fouling properties of the separation discs. The coating may be referred to as a non-stick coating and improves the separation performance of the separator. This is inter alia due to the fact that excessive fouling reducing the height of the separation passages is avoided. Furthermore, the significantly slower build-up of deposits onto the disc surfaces increases the period of time between successive requisite cleaning instances during which the separator must be ‘out of operation and taken apart. Also, the non-stick coating makes it easier to clean the disc surfaces, and any other portions of the interior of the separator that have been provided with the anti-fouling coating according to the invention. The coated separation discs may easily be cleaned just by using high pressure washing with water. Moreover, there is no need for extensive time consuming mechanical cleaning or cleaning using strong acids, bases or detergents.

According to embodiments of the present invention, the surfaces of the separator discs are coated with a composition comprising organosilicon compounds using a sol-gel process. The organosilicon compounds are starting materials used in the sol-gel process and are preferably silicon alkoxy compounds. In the sol-gel process, a sol is converted into a gel to produce nano-materials. Through hydrolysis and condensation reactions a three-dimensional network of interlayered molecules is produced in a liquid. Thermal processing stages serve to process the gel further into nano-materials or nanostructures resulting in a final coating. The coating comprising said nano-materials or nanostructures mainly comprise silicon oxide, SiOₓ, having an atomic ratio of O/Si>1, preferably an atomic ratio within the range of 1.5-3, or alternatively within the range of 2-2.5. By “an atomic ratio of O/Si>1” is meant that the number of oxygen atoms (O) of the silicon oxide (SiOₓ) divided by the number of silicon atoms (Si) of the silicon oxide (SiOₓ) is larger than one. Correspondingly, for the alternatives the number of oxygen atoms divided by the number of silicon atoms is within the range of 1.5-3, or within the range of 2-2.5.

A preferred silicon oxide is silica, SiO₂. The silicon oxide forms a three dimensional network having excellent adhesion to the surfaces of the separation discs. All discs may be coated, as well as or other surfaces within the separator subjected to fouling during separator operation. The discs may be coated on one side only, i.e. the surface facing upwards or downwards, but are preferably coated on both sides since fouling typically appears on all surfaces subjected to the fluid to be separated.

The coating of the present invention further has a content of carbon such as found in organic molecules. The organic part may or may not have functional groups such as C═O, C—O, C—O—C, C—N, N—C—O, N—C═O, etc. Preferably, the carbon content is ≧10 atomic %, preferably 20-60 atomic %, and most preferably 30-40 atomic %. The organic part impart flexibility and resilience to the coating, which is highly important during operation due to the significant forces subjected to the interior of the separator, in particular the disc stack. The organic part is hydrophobic and oleophobic, which results in the non-stick properties of the coating.

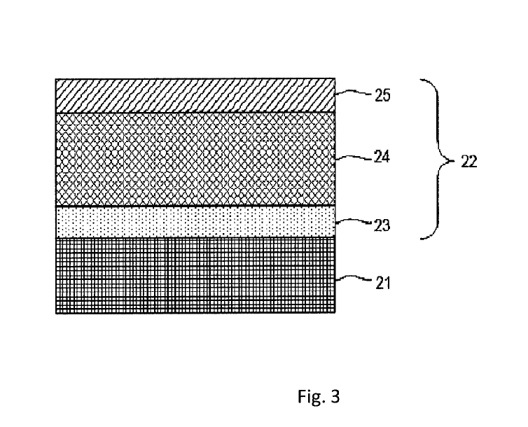

In FIG. 3 is shown a schematic illustration of a separation disc surface 21 provided with a silicon oxide sol gel coating 22, as described above. The coating is also referred to as silicon oxide layer 22. Closest to the surface 21, the silicon oxide coating 22 forms an interface 23 between the coating siloxane and a metal oxide film of the disc surface 21. A bulk of the coating 22 is the siloxane network 24 that has organic linker chains and voids that impart flexibility to the coating 22. The siloxane network 24 is on top of the interface 23. The silicon oxide layer 22 forms an outermost layer in the form of a functional surface 25 that has hydrophobic and oleophobic properties that reduces fouling. There are no sharp boundaries between the interface 23 and the siloxane network 24, and between the siloxane network 23 and the functional surface 25, respectively, but rather gradual transitions.

All separation discs that are coated may have the coating described above. The coating is both durable and flexible and provides a disc for a continuous operation centrifugal separator that has excellent non-stick properties and wear and crack resistance.

Furthermore, since the thickness of the coating is significantly less than the disc thickness, i.e. a couple of μm compared to hundreds of μm, the coating does not result in any significant reduction of the height of the separation passage, nor any significant reduction in the number of discs that can be fitted into a same height disc stack as for non-coated discs. This is a great improvement in comparison to for instance a tetrafluoropolyethylene coating which would require a thickness in the order of 100 μm, and thereby either negatively impact on the number of discs that could be fitted into a disc stack of a given height, or negatively impact on the height of the separation passage. Either way, the separation performance would be detrimentally affected.

In one embodiment, at least one sol comprising organosilicon compound is applied to the surface of the separation discs to be coated. The surface may be wetted/coated with the sol in any suitable way. The surface coating may for instance be applied by spraying, dipping or flooding. At least the separation discs of the centrifugal separator may be coated. Alternatively, all surfaces which during use in a centrifugal separator would be in contact with a fluid could be coated. For instance, all surfaces in contact with a fluid giving rise to fouling are coated.

A method of coating the surfaces comprises a pretreatment of at least the surfaces of the centrifugal separator to be coated with at least one sol. This pretreatment is also preferably carried out by means of dipping, flooding or spraying. The pretreatment is used to clean the surfaces to be coated in order to obtain increased adhesion of the latter coating to the centrifugal separator surfaces. Examples of such pretreatments are treatment with acetone and/or alkaline solutions, e.g. caustic solution.

The method of coating may comprise thermal processing stages, e.g. a drying operation may be carried out after a pretreatment and a drying and/or curing operation is often necessary after the actual coating of the surface with said sol. The coating is preferably subjected to heat using conventional heating apparatuses, such as ovens.

The coating, which as indicated above comprises SiOx, is applied to the separator disc surfaces. The application of the coating is made by means of sol-gel processing. The resulting coating on the surfaces is between 5 and 60 μm thick. The film thickness of the silicon oxide sol containing coating is 5-60 μm, preferably 5-50 μm, preferably 5-20 μm.

The material of which the separator discs are made of may be chosen from several metals and metal alloys. Preferably, the material is stainless steel. The material may also be chosen from brass or aluminum, or alloys thereof, and/or carbon steel.

### EXAMPLES

In the search for prolonged operational time of off-shore equipment, tests were conducted on low surface energy glass ceramic coatings of which both are of the type of coating described above. The coatings are referred to as Coat 1 and Coat 2, the results are presented below. Coat 1 is a silan terminated polymer in butyl acetate and Coat 2 is a polysiloxan-urethan resin in solvent naphtha/butylacetate.

The tests were performed on coated heat transfer plates. Such plates are provided in heat exchangers that may be used in a process line also containing continuous operation centrifugal separators. In other words, the media coming into contact with the heat transfer plates is often the same media that later in the process is to be separated in a centrifugal separation process. Thus, the tests performed on heat transfer plate surfaces of a heat exchanger to obtain anti-fouling characteristics for the coating may also be useful indicators for a coating on a disc surface within a centrifugal separator.

The analysis shows properties of the coatings concerning substrate wetting and adhesion, contact angle, coating thickness and stability against 1.2% HNO₃ in H₂O, 1% NaOH in H₂O and crude oil. The results are summarized below in Table 1.

TABLE 1

| | Coat 1 | Coat 2 |
|---|---|---|
| Substrate | Excellent | Excellent |
| wetting | | |
| Substrate | Al: 0/0 | Al: 0/0 |
| adhesion | Stainless steel: 0/0 | Stainless steel: 0/0 |
| | Ti: 0/0 (see below) | Ti: 0/0 (see below) |
| Contact angle | H₂O: 102-103° | H₂O: 102-103° |
| measurements | | |
| Coating | 4-10 μm | 2-4 μm |
| thickness | | |
| Stability | 1.2% HNO₃ in H₂O: | 1.2% HNO₃ in H₂O: |
| | 1½ h at 75° C. | 1½ h at 75° C. |
| | 1% NaOH in H₂O: | 1% NaOH in H₂O: |
| | 3 h at 85° C. | 2 h at 85° C. |
| | Crude oil: 6 months | Crude oil: 6 months |
| | at RT | at RT |

Both coatings showed excellent wetting when spray coated onto either stainless steel or titanium substrates.

Adhesion was determined by cross-cut/tape test according to the standard DIN EN ISO 2409. Rating is from 0 (excellent) to 5 (terrible). 0 or 1 is acceptable while 2 to 5 is not. First digit indicates rating after cross cut (1 mm grid) and the second digit gives rating after tape has been applied and taken off again.

To obtain the best adhesion for Coat 1 and Coat 2 the substrates were subjected to pre-treatment. The substrate was submerged in an alkaline cleaning detergent for 30 minutes. Afterwards, the substrate was washed with water and demineralized water and dried before Coat 1 was applied (applied within half an hour to achieve the optimal adhesion). Tests have shown that the adhesion is reduced if cleaning of the substrate is only carried out with acetone. Pre-treatment was also used for stainless steel substrates coated with Coat 2. This coating displayed unaffected adhesion whether an alkaline detergent or acetone was used as pre-treatment. If the pre-treatment step is neglected or not made correctly it will affect coating adhesion.

Both coatings showed good stability under acidic condition. The coatings were stable for 1½ hour at 75° C. and more than 24 hours at room temperature.

Under alkaline conditions Coat 1 showed a better result than Coat 2. Coat 1 could withstand the alkaline conditions for 3 hours at 85° C. and Coat 2 for 2 hours at 85° C. Both coatings showed no decomposition or reduction in oleophobic properties after being submerged in crude oil at room temperature for 6 months.

Heat transfer plates in the stack 30 were then coated with Coat 1 and Coat 2. The heat exchanger plates were in this test made of titanium and the heat exchanger 2 was used in a crude oil application. All coated heat transfer plates underwent pre-treatment, which comprised treatment with acidic and alkaline solutions to remove fouling and high pressure washing of the plates with water. The plates were left to dry before application of coating.

The pre-treatment was completed a day before Coat 1 and Coat 2 were applied to the plates. As the plates have been left to dry at ambient temperature (approximately cover 20° C.), some plates were still wet. More precisely, a third of the plates were coated with Coat 1 and a third of the plates were coated with Coat 2, while a remaining third of the plates were kept uncoated. The coating is accomplished by spraying the respective coat into the flow paths 57, 67 that are formed by the plats in the stack 30, such that the sides of the that faces the flow paths are coated. The thickness of the coating was measured to be 2-4 μm. Curing/drying for the two coatings was performed for 1½ hours in an oven at elevated temperatures of 200° C. respectively 160° C.

The stack with the coated heat transfer plates were then arranged in the heat exchanger and an evaluation of the coated plates was performed after about seven months of operation of the plate heat exchanger.

The plates were analyzed after the seven months. In detail, three different silicon oxide-coated heat transfer plates were analyzed by means of XPS (X-ray Photoelectron Spectroscopy), also known as ESCA (Electron Spectroscopy for Chemical Analysis). The XPS method provides quantitative chemical information, including a chemical composition expressed in atomic % for the outermost 2-10 nm of a surface.

A measuring principle of the XPS method comprises that a sample (i.e. a heat transfer plate coated with Coat 1, a heat transfer plate coated with Coat 2 and an uncoated plate) is placed in high vacuum and is irradiated with well-defined x-ray energy, which results in an emission of photoelectrons from the sample. Only photoelectrons from the outermost surface of the sample reach the detector. By analyzing the kinetic energy of the photoelectrons, their binding energy can be calculated, thus giving their origin in relation to a chemical element (including the electron shell) of the sample.

XPS provided quantitative data on both the elemental composition and different chemical states of a chemical element of the sample (such as different functional groups, chemical bonding, oxidation state, etc.). All chemical elements except hydrogen and helium are detected and the obtained chemical composition of the sample is expressed in atomic %.

XPS spectra were recorded using a Kratos AXIS Ultra^{DLD} x-ray photoelectron spectrometer. The samples were analyzed using a monochromatic Al x-ray source. The analysis area was below 1 mm². In the analysis so a called wide spectra run was performed to detect chemical elements present in the surface of the sample. The relative surface compositions were obtained from quantification of each chemical element.

When heat transfer plates with different types (in respect of a content of C, O and Si) of the silicon oxide coating described herein are analyzed, or more precisely when the chemical elements of the coating is analyzed, a relative surface composition in atomic % and an atomic ratio O/Si may be found. It has then been observed that mainly C, O and Si may be detected on the outermost surfaces of the coating. A content of C is typically 41.9-68.0 atomic %, a content of O is 19.5-34.3 atomic % while a content of Si is 8.6-23.4 atomic %. The atomic ratio O/Si is 1.46-2.30. Note that for the atomic ratio O/Si, the total amount of oxygen is used. This means that also oxygen in functional groups with carbon is included. Otherwise, for silica a theoretical ratio O/Si of 2.0 is expected (i.e. SiOx in form of SiO₂).

After four months of operation a pre-inspection by thermo-imaging was performed. A thermo-image was taken of a mid-region of the heat exchanger 2 when the heat exchanger was operated. From the image it was obvious that some heat transfer plates show increased heat transfer compared to other heat transfer plates in the heat exchanger.

The inspection showed an elevated temperature at the coated plates. The non-coated plates showed a lower operating temperature. The difference in temperature is an effect of different fouling, where coated plats has elevated temperatures.

A visual inspection revealed that the plates with the coating designated Coat 1 was covered with the least amount of fouling on the crude oil facing plate side. Also, Coat 2 had a reduced amount of fouling on the crude oil facing plate side compared to the bare titanium surface, but to a lesser extent then Coat 1. The bare titanium plates were completely covered in a thick layer of crude oil that “fouled” the plates. The term “fouling” is here used to describe deposits formed on the heat transfer plates during operation. The fouling is residues and deposits formed by the crude oil and consists of a waxy, organic part and a mineral/inorganic part.

By subtracting the average weight of a clean plate from the weight recorded for the individual fouled plates the average amount of fouling per surface type was calculated (table 2). The weight of the coating was not compensated for and so the real fouling reduction is slightly higher. For the heat transfer plates used in the test the heat transfer surface is 0.85 m², so for a plate with a 4 μm thick coating on both sides the total volume of coating material is around 6.8 cm³. If the coating is estimated to be pure SiO₂ (density 2.6 g/cm³) then the amount of coating per plate is about 20 g.

TABLE 2

| | Average | Fouling |
|---|---|---|
| Surface | fouling (g) | reduction (%) |
| Titanium | 585 | — |
| Coat 1 | 203 | 65 |
| Coat 2 | 427 | 27 |

For both Coat 1 and Coat 2 the fouling of the plates were more easily removed compared to the fouling on bare titanium plates, see Table 3. The difference in cleaning requirements was tested by manually wiping of the plates with a tissue and by high pressure water cleaning. Just wiping the plates with a tissue showed that the fouling was very easily removed from the coated plates, contrary to the uncoated plates. By using high pressure water cleaning all fouling except for one or two small patches could be removed from the Coat 1 coated surface. On the Coat 2 coated surface somewhat more fouling was present after water jet cleaning. This fouling had the form of slightly burnt oil. The coating was in a good condition. The crude oil has passed through the first flow path of the heat exchanger 2, while sea water has passed through the second flow path. On plate surfaces that face the seawater both coatings had deteriorated.

TABLE 3

| | Coat 1 | Coat 2 | Uncoated |
|---|---|---|---|
| View | very little fouling | reduced fouling | fouling significant |
| | | | and widespread |
| Wipe | very easy to | very easy to | fouling was not |
| with | remove fouling | remove fouling | removed |
| tissue | | | |
| High | the plates | most of the fouling | even after attempts |
| pressure | appeared as new | was removed | of manual removal |
| water | | | of fouling, still a |
| washing | | | considerable layer |
| | | | remains |

The coatings resistance to cold conditions was tested submerging the plates in liquid nitrogen having a temperature of −196° C. Next the plates were washed by high pressure water, which removed almost all fouling. No coating failure was observed for either Coat 1 or Coat 2.

An exemplary test was performed where a number of discs in a separation disc stack of a centrifugal separator for continuous operation were coated with a silicon oxide based anti-fouling coating, prepared by sol-gel processing. The separator was a large nozzle type separator with automatic continuous heavy phase or solids discharge.

The fluid mixture that was separated was an oil mixture in which heavy oil composition was separated from solids and water. This is a highly fouling mixture and both the oil composition and inorganic particles accumulate on the disc surfaces over time. The accumulation of particles, i.e. sludge deposit, may be significant already after a few days. Eventually, the separator has to be disassembled and the disc stack is removed and manually cleaned using a solvent emulsion.

The field test ran for several months. During this time, the coated discs were visually inspected at regular intervals and compared to non-coated discs. After a couple of weeks, the coated discs showed little fouling on their top surface, whereas the non-coated discs had significant fouling. On the bottom surface of the coated discs, there was some fouling, but significantly less compared to the non-coated discs. However, the fouling found on the coated discs was significantly easier to clean. After more than a month, the results were similar. At several months, the difference in fouling between the coated and non-coated surfaces were not as significant as in the early stages of the test. However, there was still an easily discernible difference in fouling and the fouling was much easier to remove.

From the description above follows that, although various embodiments of the invention have been described and shown, the invention is not restricted thereto, but may also be embodied in other ways within the scope of the subject-matter defined in the following claims.

1. A centrifugal separator arranged for continuous separation of a fluid mixture into components, comprising:
a rotor, said rotor forming within itself a separation chamber, comprising in said separation chamber a set of separation discs defining separation passages between adjacent separation discs;
an inlet operatively connected to said rotor for continuous supply of a fluid mixture to be separated in the separation chamber;
a first outlet for a separated lighter first component of the fluid mixture extending from a radially inner portion of the separation space; and
a second outlet for a separated denser second component of the fluid mixture extending from the radially outer portion of the separation space,
wherein the separation discs are at least partly provided with a coating that:
has a layer thickness of about 5-60 μm;
is prepared by sol-gel processing;
comprises silicon oxide, SiOₓ, having an atomic ratio of O/Si>1; and
comprises ≧10 atomic % of carbon.

2. The centrifugal separator according to claim 1, wherein the layer thickness of said coating has a layer thickness of about 5-50 μm.

3. The centrifugal separator according to claim 1, wherein the coating comprises silicon oxide, SiOₓ, having an atomic ratio of O/Si of 1.5-3.

4. The centrifugal separator according to claim 1, wherein the coating has a content of carbon of 20-60 atomic %.

5. The centrifugal separator according to claim 1, comprising a third outlet for a separated third component of the fluid mixture extending from the radially outer portion of the separation space.

6. The centrifugal separator according to claim 1, wherein the separation discs have a thickness of 0.3-2 mm.

7. The centrifugal separator according to claim 1, wherein the layer thickness of said coating has a layer thickness of about 5-20 μm.

8. The centrifugal separator according to claim 1, wherein the coating comprises silicon oxide, SiOₓ, having an atomic ratio of O/Si of 2-2.5.

9. The centrifugal separator according to claim 1, wherein the coating has a content of carbon of 30-40 atomic %.

10. The centrifugal separator according claim 1, wherein the separation discs have a thickness of 0.4-1 mm.

11. The centrifugal separator according claim 1, wherein the separation discs have a thickness of 0.5-0.8 mm.
